(19) United States
(12) Patent Application Publication
(10) Pub. No.: US 2022/0073809 A1
(43) Pub. Date: Mar. 10, 2022

(54) SYNTHETIC CORROSION LOGS THROUGH SUBSURFACE SPATIAL MODELING

(71) Applicant: Saudi Arabian Oil Company, Dhahran (SA)

(72) Inventor: Ayman Alkhalaf, Dhahran (SA)

(21) Appl. No.: 17/014,839

(22) Filed: Sep. 8, 2020

(51) Int. Cl. C09K 8/54; E21B 47/04; E21B 47/13

(52) U.S. Cl. CPC C09K 8/54; E21B 47/13; E21B 47/04

(57) ABSTRACT

Systems and methods include a computer-implemented method for generating synthetic corrosion logs. Processed corrosion log data is generated from historical corrosion logs of previously-drilled wells. A subset of the historical corrosion logs is selected, including selecting metal loss points to use as seed points for generating a corrosion model. The corrosion model is generated using the seed points, including using spatial interpolation to fill gaps between seed points. The corrosion model is validated by iteratively comparing seed logs and test logs to the corrosion model to ensure that the corrosion model fits the seed points within a threshold. A confidence interval is computed for each target location of a target well as a function of synthetic values associated with the seed points. A synthetic log is generated for the target well using the corrosion model, the target locations, and corresponding confidence intervals at each depth level of the target well.

### BACKGROUND

The present disclosure applies to wells used in the petroleum industry.

Petroleum companies operate large numbers of oil and gas wells that have been drilled and operated over a long period of time. Over time, wells can experience age-related issues, such as corrosion in wellbores. Corrosion can occur based on many factors, such as the presence of corrosive materials in the wellbore. As the numbers of aging wells in mature fields continue to grow, there is also an increase in the risk of suspended production due to risks related to wellbore integrity.

### SUMMARY

The present disclosure describes techniques that can be used for generating synthetic corrosion logs for wells, such as oil and gas wells used in the petroleum industry. In some implementations, a computer-implemented method includes the following. Processed corrosion log data is generated from historical corrosion logs of previously-drilled wells. A subset of the historical corrosion logs is selected, including selecting metal loss points to use as seed points for generating a corrosion model. The corrosion model is generated using the seed points, including using spatial interpolation to fill gaps between seed points. The corrosion model is validated by iteratively comparing seed logs and test logs to the corrosion model to ensure that the corrosion model fits the seed points within a threshold. A confidence interval is computed for each target location of a target well as a function of synthetic values associated with the seed points. A synthetic log is generated for the target well using the corrosion model, the target locations, and corresponding confidence intervals at each depth level of the target well.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, production engineering units can use historical logs to assess wellbore corrosion risks without having to pay for expensive corrosion logs. Second, corrosion logging acquisitions can be accelerated by utilizing swiftly-built synthetic logs.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a block diagram showing an example high-level overview of a synthetic corrosion log generation methodology, according to some implementations of the present disclosure.

FIG. 2 is a visualization showing an example of a synthetically-generated surface of metal loss, according to some implementations of the present disclosure.

FIG. 3 is a graph showing an example of a generated synthetic corrosion log, according to some implementations of the present disclosure.

FIG. 4 is a flow diagram of an example of a workflow for a full synthetic log generation pipeline, according to some implementations of the present disclosure.

FIG. 5 is a flowchart of an example of a method for generating a synthetic corrosion log, according to some implementations of the present disclosure.

FIG. 6 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for generating synthetic corrosion logs using subsurface spatial modeling. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques can be applicable to fields that have corrosion logs and upstream/production engineering practices to maintain well integrity and operation sustainability. A purpose of the research is to generate a model that synthesizes virtual corrosion logs, resulting in minimizing operational expenditures/costs.

The invention describes a method for generating synthetic corrosion logs for wells utilizing historical logs from offset wells. This is accomplished by utilizing an algorithm for spatial interpolation between measured data points and then generating a corrosion model for every field. The method also generates an uncertainty map to compute a confidence score for every synthetically-generated point. This method can be utilized to reduce costs associated with corrosion logs acquisition for never-surveyed wells in mature fields.

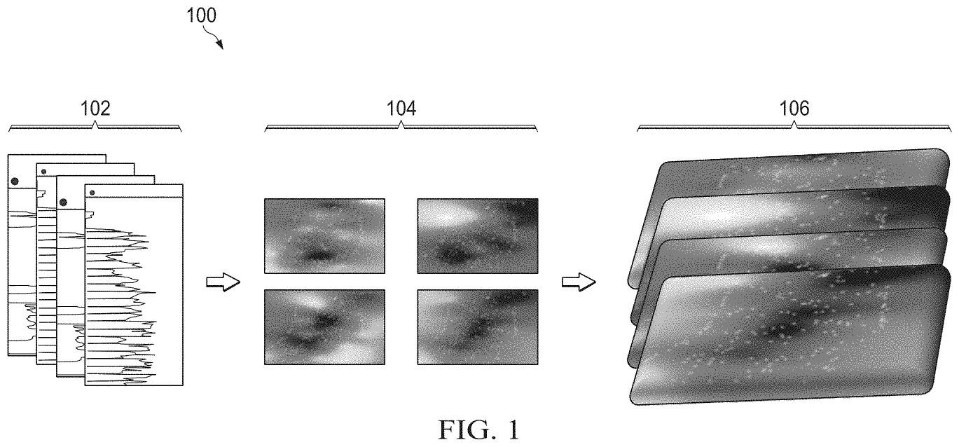

FIG. 1 is a block diagram showing an example high-level overview of a synthetic corrosion log generation methodology 100, according to some implementations of the present disclosure. The methodology 100 can start from the use (and analysis) of corrosion logs 102, from which interpolated two-dimensional (2D) surfaces 104 are generated for every depth. A three-dimensional (3D) model 106 is generated that represents all depths.

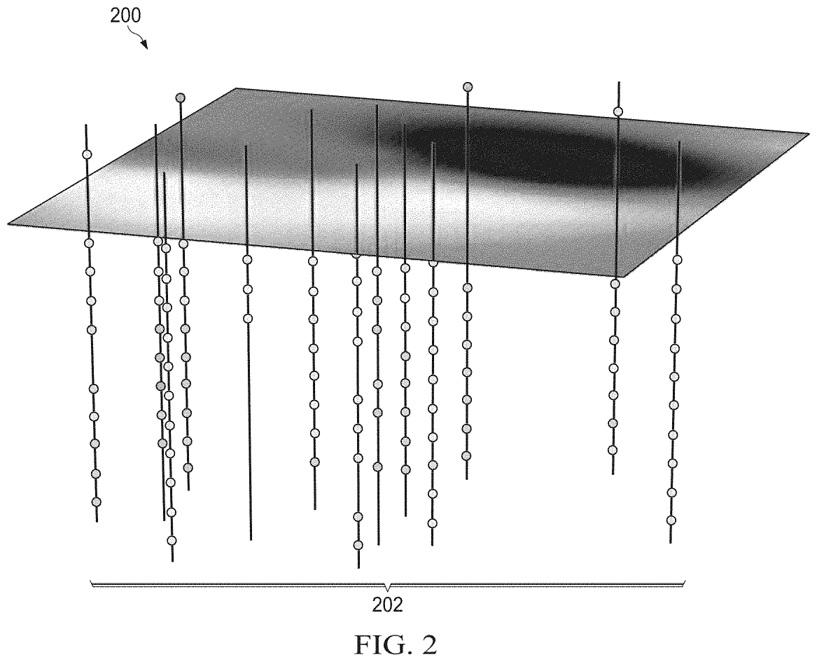

FIG. 2 is a visualization showing an example of a synthetically-generated surface 200 of metal loss, according to some implementations of the present disclosure. The generated surface 200, as shown in FIG. 2, uses existing corrosion logs at a single depth level, for example. Vertical lines 202 represent vertical wellbores. Each dot on a vertical line 202 represents a measured metal loss at a particular depth. Each different shading intensity of the dots corresponds to a unique value of metal loss.

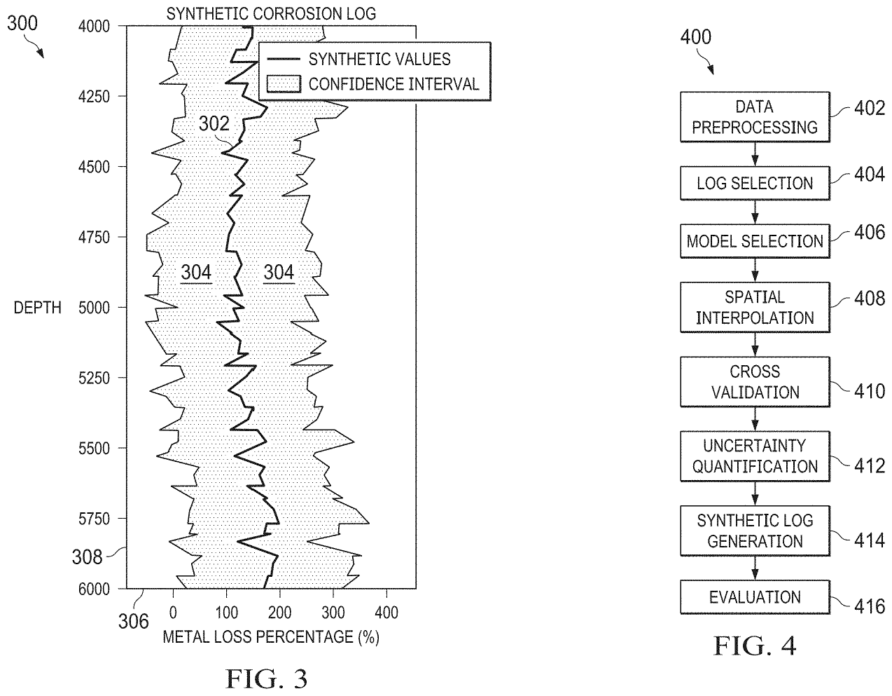

FIG. 3 is a graph showing an example of a generated synthetic corrosion log 300, according to some implementations of the present disclosure. The synthetically generated log 300 shows a synthetic values plot 302 with an associated confidence interval 304. The synthetic values plot 302 and the associated confidence interval 304 are plotted relative to a metal loss percentage axis 306 and a depth 308 (for example, in feet).

FIG. 4 is a flow diagram of an example of a workflow 400 for a full synthetic log generation pipeline, according to some implementations of the present disclosure. The workflow 400 can be used to generate the synthetic corrosion log 300, for example.

At 402, data preprocessing occurs on data that serves as an input for the workflow 400. Data used in data preprocessing can be obtained, for example, by interfacing with a database to acquire historical corrosion logs, such as for wells that have been drilled in the past. Corrosion logs can be generated, for example, by using different types of equipment to capture measurements at different depths. Corrosion logs that come from different types of equipment (for example, that may have different scales and ranges, depending on the equipment type) can be normalized to eliminate any bias caused by physical measurement devices applicable to each equipment type. In some implementations, normalization techniques that are used can include min-max normalization in which each equipment's range of values is compressed between values of 0 and 1. In some implementations, the normalization can be based on:

$${x}_{normal} = \frac{{x}_{i} - min ( X )}{max ( X ) - min ( X )} \qquad ( 1 )$$

where xᵢ is the measured value by the device, min(x) is the minimum value across all values measured by the same equipment, and max(x) is the maximum value across all values measured by the same equipment. After data preprocessing is complete, a modeling phase can occur.

At 404, as part of the modeling phase, log selection occurs in order to select specific log data to use in generating a corrosion model. In some implementations, a subset of logs can be chosen as seeds, and the remaining logs can be saved for an evaluation phase that occurs later in the workflow 400.

In some implementations, a seed selection philosophy can include choosing seeds that have a major impact on the validity of a generated model. As an example, in an effort to identify and obtain the best seeds, a risk score S can be assigned for every log, where the risk score S is determined using:

$$s = \frac{{\sum }_{i = 0}^{n} {M}_{i}}{n} \qquad ( 2 )$$

where M=(m₀, m₁, m₂, . . . , mₗ), where mᵢ>mᵢ₊₁ is always true for M (a sorted list of metal loss values in the log), where l is the number of readings in the corrosion log, and where n is a desired highest nth value in the corrosion log. For example, n can be used to control the smoothing of the highest n values in the corrosion log, and then used to govern the sensitivity of the risk score that is assigned. Seed logs can be selected in a manner that ensures that the full seed has an equal representation of various risk scores.

At 406, model selection is used to find a proper technique for filling the gaps between the seed points. For example, spatial interpolation 408 can be used for interpolating values. A spatial interpolation methodology can be inspired, for example, by a class of algorithms called Kriging algorithms. The following steps can be implemented for every depth.

The first step is to compute a variogram for the seed points (metal loss values) at every depth. The variogram quantifies the spatial dependence of the measured data points. This generates a unique model for every depth level. The formula for computing the variogram (γ) is:

$$γ ( h ) = \frac{1}{2 N ( h )} {{Σ}_{N ( h )} [ z ( u ) - z ( u + h ) ]}^{2} \qquad ( 3 )$$

where h=[hₘᵢₙ, 2hₘᵢₙ, 3hₘᵢₙ, . . . , hₘₐₓ], a predetermined list of the distances where the variogram is computed. The minimum value of h is the minimum distance between two wells in the field, the maximum value of h is the maximum distance between two wells in the field. The values between the minimum and the maximum are multiples of the minimum distance. In Equation (3), z(u) returns the metal loss value at the location u, and N(h) is the number of pairs that are an h distance apart.

After that, as a second step, an equation is fitted to approximate variogram values. This equation can take many forms. An exhaustive grid search can be conducted to find an optimal fitting equation. For example, the optimal fitting equation can be one of Equations (4) to (9):

$$\begin{matrix}Gaussian Model \text{:} p \cdot ( 1 - {e}^{- \frac{{d}^{2}}{{r}^{2}}} ) + n & ( 4 ) \\ Exponential Model \text{:} p \cdot ( 1 - {e}^{- \frac{d}{r}} ) + n & ( 5 ) \\ Spherical Model \text{:} \{ \begin{matrix}p \cdot ( \frac{d}{r} - \frac{{d}^{3}}{{r}^{3}} ) + n & d \leq r \\ p + n & d > r\end{matrix} & ( 6 ) \\ Linear Model \text{:} s \cdot d + n & ( 7 ) \\ Power Model \text{:} s \cdot {d}^{e} + n & ( 8 ) \\ Hole Effect Model \text{:} p \cdot ( 1 - ( 1 - \frac{d}{\frac{r}{3}} ) * {e}^{- \frac{d}{\frac{r}{3}}} ) + n & ( 9 )\end{matrix}$$

In Equations (4) to (9), variables/terms are defined as: values of d are distance values at which the variogram is computed, p is a partial sill (partial sill=sill−nugget), r is a range of the variogram (the distance after which the covariance remains the highest), n is a nugget, s is a scaling factor or slope, and e is an exponent for the power model.

Lastly, as a third step, the optimal fitting equation that is selected is used when computing values for empty spaces between the seed points by plugging the distance between the target location and all known locations into the fitted model iteratively.

At 410, after the modeling phase is completed, cross-validation occurs. The model can be trained iteratively with different seed logs and different test logs to ensure that the model is a true fit. Each cross validation run can rerun the entire synthetic surface generation step.

At 412, uncertainty quantification occurs. For example, for every target location, there is a population of possible synthetic values that honors the seed points. The variance can be computed for this population of values. After that, the confidence interval can be computed as a function of the variance.

At 414, synthetic log generation occurs. The coordinates of the target well can be placed on the resulting grid at every depth level to capture the resulting value and the associated confidence interval.

At 416, evaluation occurs. The goal of the evaluation phase is to assess whether the model is accurate or not. The assessment can be completed by comparing values in the grid to values unseen by the model. In some implementations, metrics can be used to quantify the accuracy of the synthetically-generated points. In a first example, the mean squared error (MSE) between an actual value and a predicted value can be computed. A second example can use high metal loss detection, including using a binary evaluator at the log level. A value of 1 can be used if high metal loss is detected, and a value of 0 can be used if high metal loss hasn't been detected within a varying tolerance level, for example, a pre-defined number of feet (for example, one foot).

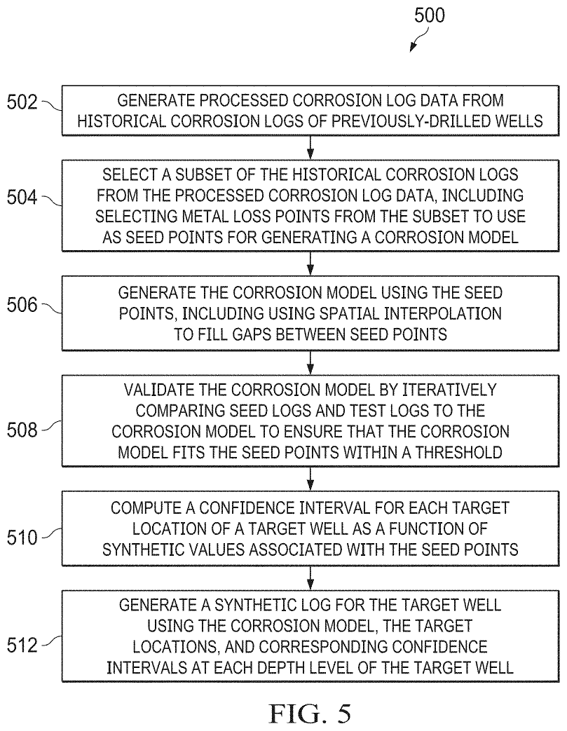

FIG. 5 is a flowchart of an example of a method 500 for generating a synthetic corrosion log, according to some implementations of the present disclosure. For clarity of presentation, the description that follows generally describes method 500 in the context of the other figures in this description. However, it will be understood that method 500 can be performed, for example, by any suitable system, environment, software, and hardware, or a combination of systems, environments, software, and hardware, as appropriate. In some implementations, various steps of method 500 can be run in parallel, in combination, in loops, or in any order.

At 502, processed corrosion log data is generated from historical corrosion logs of previously-drilled wells. For example, generating the processed corrosion log data from the historical corrosion logs of the previously-drilled wells can includes normalizing data for each type of equipment to fit the data into a normalized range of values. In some implementations, Equation (1) can be used for normalizing corrosion log data. From 502, method 500 proceeds to 504.

At 504, a subset of the historical corrosion logs is selected from the processed corrosion log data, including selecting metal loss points from the subset to use as seed points for generating a corrosion model. In some implementations, selecting the subset of the historical corrosion logs to use as the seed points can include the use of Equation (2), as previously described. For example, a risk score can be assigned to each historical corrosion log, where the risk score is based on a summation of metal loss values from the historical corrosion log. Then, the subset of the historical corrosion logs can be selected based on the risks having lowest average metal loss summations. From 504, method 500 proceeds to 506.

At 506, the corrosion model is generated using the seed points, including using spatial interpolation to fill gaps between seed points. For example, spatial interpolation can be used to fill the gaps between seed points includes generating variograms values quantifying spatial distances between the seed points. In some implementations, spatial interpolation and generating the variograms can include using one or more fitting equations from a group of models including a Gaussian model, an exponential model, a spherical model, a liner model, a power model, and a hole effect model. From 506, method 500 proceeds to 508.

At 508, the corrosion model is validated by iteratively comparing seed logs and test logs to the corrosion model to ensure that the corrosion model fits the seed points within a threshold. Validation can use techniques described with respect to step 416 of FIG. 4, for example. From 508, method 500 proceeds to 510.

At 510, a confidence interval is computed for each target location of a target well as a function of synthetic values associated with the seed points. The synthetic values plot 302 can have an associated confidence interval 304, for example. From 510, method 500 proceeds to 512.

At 512, a synthetic log is generated for the target well using the corrosion model, the target locations, and corresponding confidence intervals at each depth level of the target well. As an example, the synthetic corrosion log 300 can be generated, as described previously. After 512, method 500 can stop.

In some implementations, method 500 further includes evaluating the corrosion model. For example, evaluating the corrosion model can include quantifying accuracies of synthetically-generated points in the synthetic log generated for the target well.

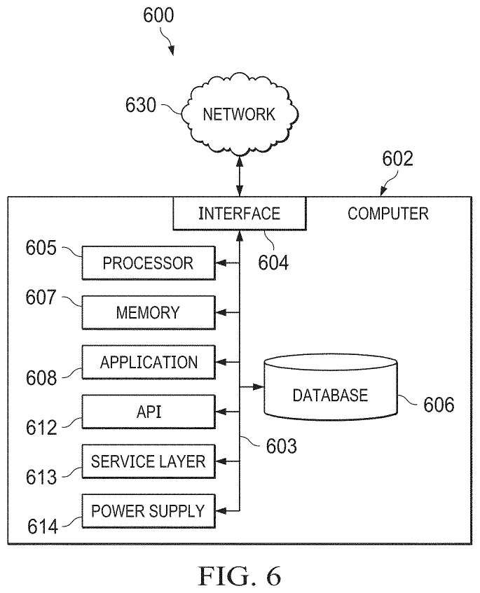

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a top level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both) over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Described implementations of the subject matter can include one or more features, alone or in combination.

For example, in a first implementation, a computer-implemented method includes the following. Processed corrosion log data is generated from historical corrosion logs of previously-drilled wells. A subset of the historical corrosion logs is selected from the processed corrosion log data, including selecting metal loss points from the subset to use as seed points for generating a corrosion model. The corrosion model is generated using the seed points, including using spatial interpolation to fill gaps between seed points. The corrosion model is validated by iteratively comparing seed logs and test logs to the corrosion model to ensure that the corrosion model fits the seed points within a threshold. A confidence interval is computed for each target location of a target well as a function of synthetic values associated with the seed points. A synthetic log is generated for the target well using the corrosion model, the target locations, and corresponding confidence intervals at each depth level of the target well.

The foregoing and other described implementations can each, optionally, include one or more of the following features:

A first feature, combinable with any of the following features, where generating the processed corrosion log data from the historical corrosion logs of the previously-drilled wells includes normalizing data for each type of equipment to fit the data into a normalized range of values.

A second feature, combinable with any of the previous or following features, where selecting the subset of the historical corrosion logs to use as the seed points includes: assigning a risk score to each historical corrosion log, wherein the risk score is based on a summation of metal loss values from the historical corrosion log; and selecting the subset of the historical corrosion logs based on the risks having lowest average metal loss summations.

A third feature, combinable with any of the previous or following features, where using spatial interpolation to fill the gaps between seed points includes generating variograms values quantifying spatial distances between the seed points.

A fourth feature, combinable with any of the previous or following features, where generating the variograms values includes using one or more fitting equations from a group of models including a Gaussian model, an exponential model, a spherical model, a liner model, a power model, and a hole effect model.

A fifth feature, combinable with any of the previous or following features, the method further including evaluating the corrosion model.

A sixth feature, combinable with any of the previous or following features, where evaluating the corrosion model includes quantifying accuracies of synthetically-generated points in the synthetic log generated for the target well.

In a second implementation, a non-transitory, computer-readable medium stores one or more instructions executable by a computer system to perform operations including the following. Processed corrosion log data is generated from historical corrosion logs of previously-drilled wells. A subset of the historical corrosion logs is selected from the processed corrosion log data, including selecting metal loss points from the subset to use as seed points for generating a corrosion model. The corrosion model is generated using the seed points, including using spatial interpolation to fill gaps between seed points. The corrosion model is validated by iteratively comparing seed logs and test logs to the corrosion model to ensure that the corrosion model fits the seed points within a threshold. A confidence interval is computed for each target location of a target well as a function of synthetic values associated with the seed points. A synthetic log is generated for the target well using the corrosion model, the target locations, and corresponding confidence intervals at each depth level of the target well.

The foregoing and other described implementations can each, optionally, include one or more of the following features:

A first feature, combinable with any of the following features, where generating the processed corrosion log data from the historical corrosion logs of the previously-drilled wells includes normalizing data for each type of equipment to fit the data into a normalized range of values.

A second feature, combinable with any of the previous or following features, where selecting the subset of the historical corrosion logs to use as the seed points includes: assigning a risk score to each historical corrosion log, wherein the risk score is based on a summation of metal loss values from the historical corrosion log; and selecting the subset of the historical corrosion logs based on the risks having lowest average metal loss summations.

A third feature, combinable with any of the previous or following features, where using spatial interpolation to fill the gaps between seed points includes generating variograms values quantifying spatial distances between the seed points.

A fourth feature, combinable with any of the previous or following features, where generating the variograms values includes using one or more fitting equations from a group of models including a Gaussian model, an exponential model, a spherical model, a liner model, a power model, and a hole effect model.

A fifth feature, combinable with any of the previous or following features, the operations further including evaluating the corrosion model.

A sixth feature, combinable with any of the previous or following features, where evaluating the corrosion model includes quantifying accuracies of synthetically-generated points in the synthetic log generated for the target well.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Processed corrosion log data is generated from historical corrosion logs of previously-drilled wells. A subset of the historical corrosion logs is selected from the processed corrosion log data, including selecting metal loss points from the subset to use as seed points for generating a corrosion model. The corrosion model is generated using the seed points, including using spatial interpolation to fill gaps between seed points. The corrosion model is validated by iteratively comparing seed logs and test logs to the corrosion model to ensure that the corrosion model fits the seed points within a threshold. A confidence interval is computed for each target location of a target well as a function of synthetic values associated with the seed points. A synthetic log is generated for the target well using the corrosion model, the target locations, and corresponding confidence intervals at each depth level of the target well.

The foregoing and other described implementations can each, optionally, include one or more of the following features:

A first feature, combinable with any of the following features, where generating the processed corrosion log data from the historical corrosion logs of the previously-drilled wells includes normalizing data for each type of equipment to fit the data into a normalized range of values.

A second feature, combinable with any of the previous or following features, where selecting the subset of the historical corrosion logs to use as the seed points includes: assigning a risk score to each historical corrosion log, wherein the risk score is based on a summation of metal loss values from the historical corrosion log; and selecting the subset of the historical corrosion logs based on the risks having lowest average metal loss summations.

A third feature, combinable with any of the previous or following features, where using spatial interpolation to fill the gaps between seed points includes generating variograms values quantifying spatial distances between the seed points.

A fourth feature, combinable with any of the previous or following features, where generating the variograms values includes using one or more fitting equations from a group of models including a Gaussian model, an exponential model, a spherical model, a liner model, a power model, and a hole effect model.

A fifth feature, combinable with any of the previous or following features, the operations further including evaluating the corrosion model.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
generating processed corrosion log data from historical corrosion logs of previously-drilled wells;
selecting a subset of the historical corrosion logs from the processed corrosion log data, including selecting metal loss points from the subset to use as seed points for generating a corrosion model;
generating the corrosion model using the seed points, including using spatial interpolation to fill gaps between seed points;
validating the corrosion model by iteratively comparing seed logs and test logs to the corrosion model to ensure that the corrosion model fits the seed points within a threshold;
computing a confidence interval for each target location of a target well as a function of synthetic values associated with the seed points; and
generating a synthetic log for the target well using the corrosion model, the target locations, and corresponding confidence intervals at each depth level of the target well.

2. The computer-implemented method of claim 1, wherein generating the processed corrosion log data from the historical corrosion logs of the previously-drilled wells includes normalizing data for each type of equipment to fit the data into a normalized range of values.

3. The computer-implemented method of claim 1, wherein selecting the subset of the historical corrosion logs to use as the seed points includes:
assigning a risk score to each historical corrosion log, wherein the risk score is based on a summation of metal loss values from the historical corrosion log; and
selecting the subset of the historical corrosion logs based on the risks having lowest average metal loss summations.

4. The computer-implemented method of claim 1, wherein using spatial interpolation to fill the gaps between seed points includes generating variograms values quantifying spatial distances between the seed points.

5. The computer-implemented method of claim 4, wherein generating the variograms values includes using one or more fitting equations from a group of models comprising a Gaussian model, an exponential model, a spherical model, a liner model, a power model, and a hole effect model.

6. The computer-implemented method of claim 1, further comprising evaluating the corrosion model.

7. The computer-implemented method of claim 6, wherein evaluating the corrosion model includes quantifying accuracies of synthetically-generated points in the synthetic log generated for the target well.

8. A non-transitory, computer-readable medium storing one or more instructions executable by a computer system to perform operations comprising:
generating processed corrosion log data from historical corrosion logs of previously-drilled wells;
selecting a subset of the historical corrosion logs from the processed corrosion log data, including selecting metal loss points from the subset to use as seed points for generating a corrosion model;
generating the corrosion model using the seed points, including using spatial interpolation to fill gaps between seed points;
validating the corrosion model by iteratively comparing seed logs and test logs to the corrosion model to ensure that the corrosion model fits the seed points within a threshold;
computing a confidence interval for each target location of a target well as a function of synthetic values associated with the seed points; and
generating a synthetic log for the target well using the corrosion model, the target locations, and corresponding confidence intervals at each depth level of the target well.

9. The non-transitory, computer-readable medium of claim 8, wherein generating the processed corrosion log data from the historical corrosion logs of the previously-drilled wells includes normalizing data for each type of equipment to fit the data into a normalized range of values.

10. The non-transitory, computer-readable medium of claim 8, wherein selecting the subset of the historical corrosion logs to use as the seed points includes:
assigning a risk score to each historical corrosion log, wherein the risk score is based on a summation of metal loss values from the historical corrosion log; and
selecting the subset of the historical corrosion logs based on the risks having lowest average metal loss summations.

11. The non-transitory, computer-readable medium of claim 8, wherein using spatial interpolation to fill the gaps between seed points includes generating variograms values quantifying spatial distances between the seed points.

12. The non-transitory, computer-readable medium of claim 11, wherein generating the variograms values includes using one or more fitting equations from a group of models comprising a Gaussian model, an exponential model, a spherical model, a liner model, a power model, and a hole effect model.

13. The non-transitory, computer-readable medium of claim 8, the operations further comprising evaluating the corrosion model.

14. The non-transitory, computer-readable medium of claim 13, wherein evaluating the corrosion model includes quantifying accuracies of synthetically-generated points in the synthetic log generated for the target well.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
generating processed corrosion log data from historical corrosion logs of previously-drilled wells;
selecting a subset of the historical corrosion logs from the processed corrosion log data, including selecting metal loss points from the subset to use as seed points for generating a corrosion model;
generating the corrosion model using the seed points, including using spatial interpolation to fill gaps between seed points;
validating the corrosion model by iteratively comparing seed logs and test logs to the corrosion model to ensure that the corrosion model fits the seed points within a threshold;
computing a confidence interval for each target location of a target well as a function of synthetic values associated with the seed points; and
generating a synthetic log for the target well using the corrosion model, the target locations, and corresponding confidence intervals at each depth level of the target well.

16. The computer-implemented system of claim 15, wherein generating the processed corrosion log data from the historical corrosion logs of the previously-drilled wells includes normalizing data for each type of equipment to fit the data into a normalized range of values.

17. The computer-implemented system of claim 15, wherein selecting the subset of the historical corrosion logs to use as the seed points includes:
assigning a risk score to each historical corrosion log, wherein the risk score is based on a summation of metal loss values from the historical corrosion log; and
selecting the subset of the historical corrosion logs based on the risks having lowest average metal loss summations.

18. The computer-implemented system of claim 15, wherein using spatial interpolation to fill the gaps between seed points includes generating variograms values quantifying spatial distances between the seed points.

19. The computer-implemented system of claim 18, wherein generating the variograms values includes using one or more fitting equations from a group of models comprising a Gaussian model, an exponential model, a spherical model, a liner model, a power model, and a hole effect model.

20. The computer-implemented system of claim 15, the operations further comprising evaluating the corrosion model.
